(19) United States
(12) Patent Application Publication
(10) Pub. No.: US 2026/0013564 A1
(43) Pub. Date: Jan. 15, 2026

(54) AEROSOL GENERATING DEVICE AND AEROSOL GENERATING SYSTEM

(71) Applicant: KT&G CORPORATION, Daejeon (KR)

(72) Inventors: Sang Kyu PARK, Seoul (KR); Jae Min LEE, Siheung-si, Gyeonggi-do (KR)

(73) Assignee: KT&G CORPORATION, Daejeon (KR)

(21) Appl. No.: 18/994,274

(22) PCT Filed: Dec. 15, 2023
(86) PCT No.: PCT/KR2023/020779

§ 371 Date: Jan. 14, 2025

(30) Foreign Application Priority Data
Dec. 16, 2022 (KR) 10-2022-0177507
May 4, 2023 (KR) 10-2023-0058555

(51) Int. Cl. A24F 40/465; A24F 40/20; A24F 40/51; A24F 40/53; A24F 40/57; A24F 40/60; A24F 40/65; H02M 7/5395

(52) U.S. Cl. CPC A24F 40/465; A24F 40/51; H02M 7/5395; A24F 40/20; A24F 40/53; A24F 40/57; A24F 40/60; A24F 40/65

(57) ABSTRACT

An aerosol generating device includes a heater including a coil and a susceptor, an alternating current detector configured to detect alternating current power caused by an inductive coupling phenomenon between the coil and the susceptor, a memory storing a look-up table including temperature matching data of the susceptor corresponding to the alternating current power, and a controller configured to calculate a temperature of the susceptor based on the alternating current power received from the alternating current detector and the look-up table.

### TECHNICAL FIELD

The present disclosure relates to an aerosol generating devices and an aerosol generating system. Specifically, the present disclosure relates to calculation of a temperature of a susceptor in an aerosol generating device using an induction heating method.

### BACKGROUND ART

In addition to an internal heating method and an external heating method, an induction heating method using a coil and a susceptor is used to heat cigarettes (or aerosol generating articles). In the induction heating method, when an AC voltage is applied to a coil, a magnetic field is generated by the coil, and a temperature of a susceptor increases due to the magnetic field. A cigarette is heated by the susceptor to generate an aerosol.

When the susceptor is heated by using the induction heating method, the temperature of the susceptor may be measured in a contact manner, such as by attaching a temperature sensor to the susceptor, or in a non-contact manner by using an infrared temperature sensor or so on.

However, when measuring the temperature by using a contact method in which a temperature sensor is attached to a susceptor, the temperature sensor may not be separated from the susceptor and has to be fixed to an aerosol generating device, and when the temperature sensor is detached, a measurement error may occur when the temperature sensor is attached or detached again.

Also, when measuring the temperature of the susceptor by using a non-contact method using an infrared temperature sensor or so on, and when contamination occurs on a surface of the temperature sensor, the temperature of the susceptor may not be accurately measured, and when considering a focal length of a temperature sensor, it may not be possible to reduce the size of aerosol generating devices.

### DISCLOSURE

### Technical Problem

The present disclosure provides an aerosol generating device and an aerosol generating system that may be reduced in size and may accurately measure a temperature of a susceptor.

Objects to be achieved by embodiments of the present disclosure are not limited to the objects described above, and objects not described will be clearly understood by those skilled in the art to which the embodiments belong from the present specification and accompanying drawings.

### Technical Solution

According to an aspect of the present disclosure, an aerosol generating device includes a heater including a coil and a susceptor, an alternating current detector configured to detect AC power caused by an inductive coupling phenomenon between the coil and the susceptor, a memory storing a look-up table including temperature matching data about the susceptor, the temperature matching data corresponding to the AC power, and a controller configured to calculate a temperature of the susceptor based on the AC power received from the alternating current detector based on the look-up table.

According to another aspect of the present disclosure, an aerosol generation system includes a cigarette and an aerosol generating device. The cigarette includes a susceptor, and the aerosol generating device includes a heater including a coil for inductively heating the susceptor, an alternating current detector configured to detect AC power generated by an inductive coupling phenomenon between the coil and the susceptor, a memory storing a look-up table including temperature matching data about the susceptor, the temperature matching data corresponding to the AC power, and a controller configured to calculate a temperature of the susceptor based on the detected AC power and the look-up table.

### Advantageous Effects

An aerosol generating device and an aerosol generating system according to various embodiments of the present disclosure calculate a temperature of a susceptor based on a change in AC power generated by an induction heater of the aerosol generating device, and thus, the aerosol generating device may be reduced in size and a temperature of the susceptor may be accurately measured.

Effects of the embodiments are not limited to the effects described above, and effects not described may be clearly understood by those skilled in the art to which the embodiments belong from the present specification and the accompanying drawings.

### DESCRIPTION OF DRAWINGS

FIGS. 1 and 2 are views illustrating aerosol generating devices of an induction heating type.

FIGS. 3 and 4 are views illustrating examples of cigarettes.

FIGS. 5 and 6 are views illustrating examples of cigarettes inserted into aerosol generating devices.

FIG. 7 is a block diagram illustrating a hardware configuration of an aerosol generating device.

FIGS. 8 and 9 are cross-sectional views of a susceptor to illustrate a skin effect appearing in the susceptor.

FIG. 10 is a block diagram illustrating a hardware configuration of an aerosol generation system.

FIG. 11 is a flowchart illustrating an operating method of an aerosol generating device, according to an embodiment.

FIG. 12 is a block diagram of an aerosol generating device according to another embodiment.

### BEST MODE

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, embodiments of the present disclosure are described in detail with reference to the attached drawings such that those skilled in the art to which the present disclosure belongs may easily implement the present disclosure. However, the present disclosure may be implemented in many different forms and is not limited to the embodiments described herein.

Hereinafter, embodiments of the present disclosure are described in detail with reference to the drawings.

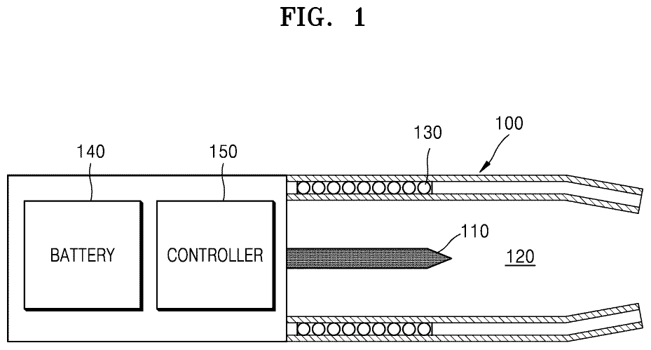

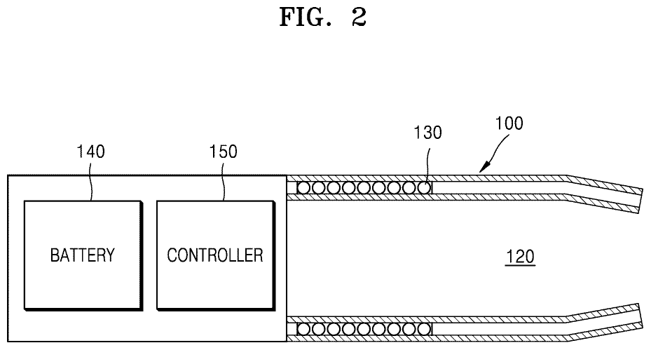

FIGS. 1 and 2 are views illustrating aerosol generating devices of an induction heating type.

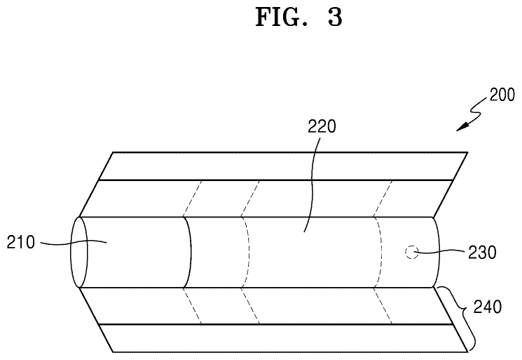

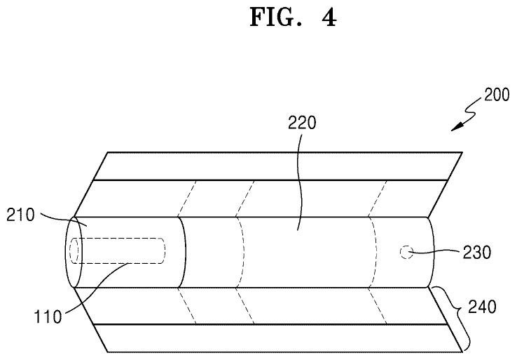

Referring to FIG. 1, an aerosol generating device 100 may include a susceptor 110, an accommodation space 120, a coil 130, a battery 140, and a controller 150. According to an embodiment, the susceptor 110 may be included in a cigarette 200 (see FIGS. 3 and 4). In this case, the aerosol generating device 100 may not include the susceptor 110 as illustrated in FIG. 2.

Components related to the present embodiments are included in the aerosol generating device 100 illustrated in FIGS. 1 and 2. Accordingly, those skilled in the art related to the present embodiments may understand that, in addition to the components illustrated in FIGS. 1 and 2, other general-purpose components may be further included in the aerosol generating device 100.

The aerosol generating device 100 may generate an aerosol by heating the cigarette 200 accommodated in the aerosol generating device 100 by using an induction heating method. The induction heating method may refer to a method of generating heat from a magnetic material by applying an alternating magnetic field of which direction changes periodically to the magnetic material that generates heat by an external magnetic field.

When the alternating magnetic field is applied to the magnetic material, energy loss due to an eddy current loss and hysteresis loss may occur in the magnetic material, and the lost energy may be emitted from the magnetic material as heat energy. The larger the amplitude or frequency of the alternating magnetic field applied to the magnetic material, the more heat energy may be emitted from the magnetic material. The aerosol generating device 100 may emit heat energy from a magnetic material by applying an alternating magnetic field to the magnetic material and may transfer the heat energy emitted from the magnetic material to the cigarette 200.

A magnetic material that generates heat by an external magnetic field may be the susceptor 110. The susceptor 110 may have a shape of a piece, a slice, a strip, or so on.

The susceptor 110 may include metal or carbon. The susceptor 110 may include at least one of ferrite, ferromagnetic alloy, stainless steel, and aluminum (Al). Also, the susceptor 110 may also include at least one of graphite, molybdenum, silicon carbide, niobium, nickel alloy, metal film, ceramic such as zirconia, transition metal such as nickel (Ni) or cobalt (Co), and metalloid such as boron (B) or phosphorus (P).

The aerosol generating device 100 may include the accommodating space 120 for accommodating the cigarette 200. The accommodation space 120 may include an opening that opens outside the accommodation space 120 to accommodate the cigarette 200 in the aerosol generating device 100. The cigarette 200 may be accommodated in the aerosol generating device 100 through the opening of the accommodation space 120 in a direction from the outside of the accommodation space 120 toward the inside of the accommodation space 120.

As illustrated in FIG. 1, the susceptor 110 may be arranged at an inner end of the accommodation space 120. The susceptor 110 may be attached to a bottom surface formed at the inner end of the accommodation space 120. The cigarette 200 may be inserted into the susceptor 110 from an upper end of the susceptor 110 and may be accommodated on the bottom surface of the accommodation space 120.

Alternatively, as illustrated in FIG. 2, the aerosol generating device 100 may not include the susceptor 110. In this case, the susceptor 110 may be included in the cigarette 200 (see FIG. 4).

The coil 130 may be implemented as a solenoid. The coil 130 may be a solenoid wound along the side of the accommodation space 120, and the cigarette 200 may be accommodated in an inner space of the solenoid. A material of a conductor constituting the solenoid may be copper (Cu). However, the material is not limited thereto, and is a material that has a low resistivity value and allows a high current to flow therethrough, and any one of silver (Ag), gold (Au), aluminum (Al), tungsten (W), zinc (Zn), and nickel (Ni), or an alloy including at least one thereof may be the material of the conductor constituting the solenoid.

The coil 130 may be wound along an outer surface of the accommodation space 120 and may be placed at a position corresponding to the susceptor 110.

The battery 140 is a direct current (DC) power supply and may supply a DC voltage to the controller 150 for operation of the aerosol generating device 100. In one embodiment, a regulator that maintains a voltage of the battery 140 constant may be between the battery 140 and the controller 150. The battery 140 may be a lithium iron phosphate (LiFePO4) battery but is not limited thereto. For example, the battery may be a lithium cobalt oxide (LiCoO2) battery, a lithium titanate battery, or so on.

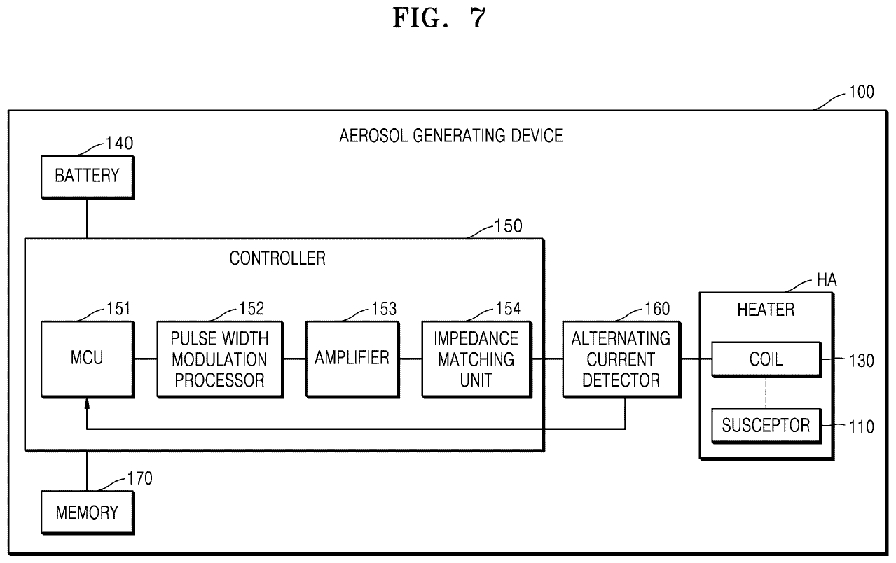

The controller 150 may control the power supplied to the coil 130. The controller 150 may inductively heat the susceptor 110 by controlling driving frequencies. Also, alternating current (AC) power varied by induction heating of the susceptor 110 may be detected, and a temperature of the susceptor 110 may be calculated based on the detected AC power. An induction heating method of the controller 150 and a temperature calculation method of the susceptor 110 are described below with reference to FIGS. 7 to 11.

FIGS. 3 and 4 are views illustrating examples of cigarettes.

Referring to FIGS. 3 to 4, the cigarettes 200 may each include a tobacco rod 210 and a filter rod 220. Although FIGS. 3 and 4 illustrate that the filter rod 220 is composed of a single region, but the present disclosure is not limited thereto, and the filter rod 220 may be composed of a plurality of segments. For example, the filter rod 220 may include a first segment that cools an aerosol and a second segment that filters a preset component included in the aerosol. Also, the filter rod 220 may further include at least one segment that performs another function.

The cigarette 200 may be wrapped by at least one wrapper 240. At least one hole may be formed in the wrapper 240 through which external air flows in or internal air flows out. In one example, the cigarette 200 may be wrapped by one wrapper 240. In another example, the cigarette 200 may be overlappingly wrapped by two or more wrappers 240. In detail, the tobacco rod 210 may be wrapped a first wrapper, and the filter rod 220 may be wrapped by a second wrapper. The tobacco rod 210 and the filter rod 220 respectively wrapped by the first and second wrappers may be combined with each other, and the entire cigarette 200 may be rewrapped by a third wrapper.

The tobacco rod 210 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol but is not limited thereto. The tobacco rod 210 may include another additive, such as a flavoring agent, a wetting agent, and/or organic acid. A flavoring liquid, such as menthol or moisturizer, may be added to the tobacco rod 210 by spraying the flavoring liquid onto the tobacco rod 210.

The tobacco rod 210 may be manufactured in various ways. For example, the tobacco rod 210 may be manufactured as a sheet or a strand. Alternatively, the tobacco rod 210 may be manufactured of cut tobacco in which a tobacco sheet is cut into small pieces.

According to an embodiment, the cigarette 200 may further include the susceptor 110. In this case, the susceptor 110 may be included in the tobacco rod 210 as illustrated in FIG. 4. A shape of the susceptor 110 may be a rod shaped extending from an end of the tobacco rod 210 toward the filter rod 220.

The tobacco rod 210 may be surrounded by a heat-conducting material. For example, the heat-conducting material may be metal foil, such as aluminum foil but is not limited thereto. A heat-conducting material surrounding the tobacco rod 210 may improve conductivity of heat applied to the tobacco rod 210 by evenly distributing the heat transferred to the tobacco rod 210, and accordingly, the flavor of an aerosol generated by the tobacco rod 210 may be increased.

The filter rod 220 may be a cellulose acetate filter. The filter rod 220 may have various shapes. For example, the filter rod 220 may be a cylindrical rod or a tubular rod having a hollow therein. Alternatively, the filter rod 220 may also be a recess-type rod having a cavity therein. When the filter rod 220 is composed of a plurality of segments, the plurality of segments may have shapes that are different from each other.

The filter rod 220 may be manufactured such that flavor is generated therefrom. For example, a flavoring liquid may be sprayed onto the filter rod 220, and a separate fiber coated with the flavoring liquid may also be inserted into the filter rod 220.

The filter rod 220 may include at least one capsule 230. The capsule 230 may generate flavor and may also generate an aerosol. For example, the capsule 230 may have a structure that surrounds a liquid containing fragrance with a film. The capsule 230 may have a spherical or cylindrical shape but is not limited thereto.

When the filter rod 220 includes a cooling segment for cooling an aerosol, the cooling segment may be made of a polymer material or a biodegradable polymer material. For example, the cooling segment may be made entirely of pure polylactic acid. Alternatively, the cooling segment may be made of a cellulose acetate filter including a plurality of perforations. However, the present disclosure is not limited thereto, and the cooling segment may be composed of a structure and material for cooling an aerosol.

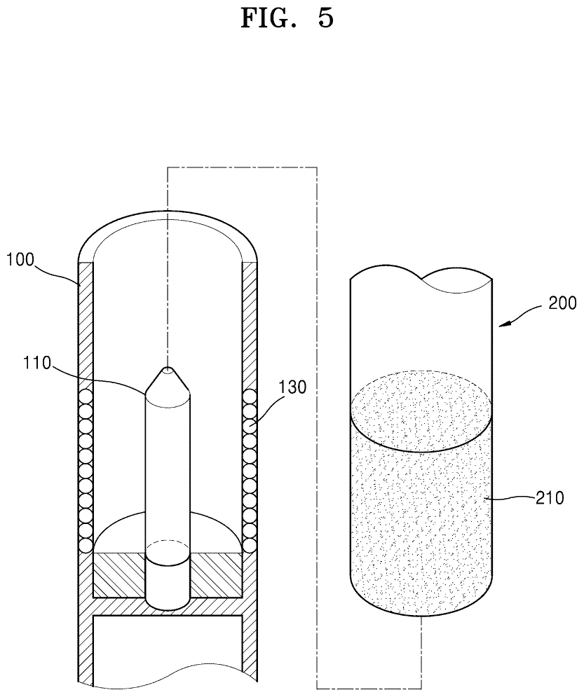

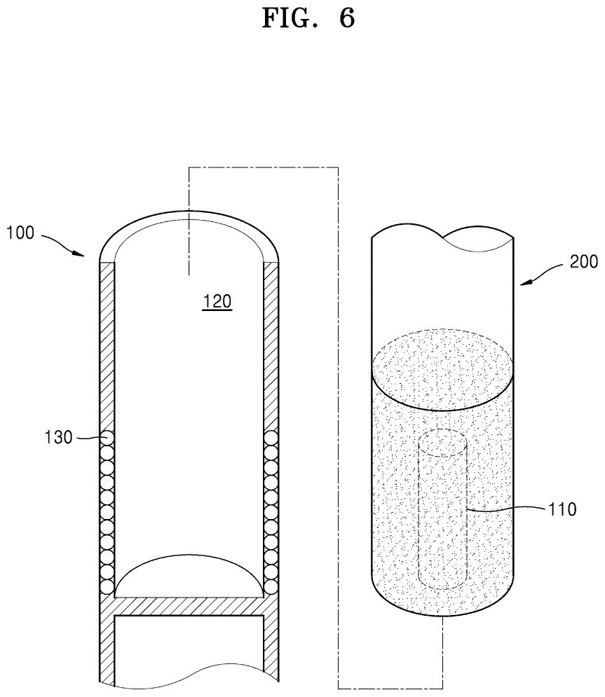

FIGS. 5 and 6 are views illustrating examples of cigarettes inserted into aerosol generating devices.

More specifically, FIG. 5 is a view illustrating an example of a cigarette 200 inserted into an aerosol generating device 100 when the susceptor 110 is included in the aerosol generating device 100, and FIG. 6 is a view illustrating an example of a cigarette 200 inserted into an aerosol generating device 100 when the susceptor 110 is included in a cigarette 200.

Referring to FIG. 5, the cigarette 200 may be accommodated in an accommodation space 120 in a longitudinal direction of the cigarette 200. The susceptor 110 may be inserted into the cigarette 200 accommodated in the aerosol generating device 100. As the susceptor 110 is inserted into the cigarette 200, the tobacco rod 210 may come into contact with the susceptor 110. A shape of the susceptor 110 may have a needle-like structure extending in a longitudinal direction of the aerosol generating device 100 such that the susceptor 110 may be inserted into the cigarette 200.

The susceptor 110 may be placed at the center of the accommodation space 120 to be inserted into the center of the cigarette 200. Although FIG. 5 illustrates that the susceptor 110 is single, the present disclosure is not limited thereto. In other words, the aerosol generating device 100 of the present disclosure may include a plurality of susceptors 110 that extend in the longitudinal direction of the aerosol generating device 100 to be inserted into the cigarette 200 and are parallel to each other.

The coil 130 may be wound along an outer surface of the accommodation space 120 and extend in a longitudinal direction. The coil 130 extending in the longitudinal direction may be on the outer surface of the accommodation space 120. The coil 130 may extend in the longitudinal direction to a length corresponding to a length of the susceptor 110 and may be at a position corresponding to a position of the susceptor 110.

Referring to FIG. 6, the cigarette 200 may be accommodated in the accommodation space 120 in a longitudinal direction of the cigarette 200. As the cigarette 200 is inserted into the accommodation space 120, the susceptor 110 may be surrounded by the coil 130.

The susceptor 110 may be at the center of the tobacco rod 210 for uniform heat transfer. Although FIG. 6 illustrates that the susceptor 110 is single, the present disclosure is not limited thereto. In other words, the aerosol generating device 100 of the present disclosure may include a plurality of susceptors 110 included in the cigarette 200.

The coil 130 may be wound along an outer surface of the accommodation space 120 and extend in a longitudinal direction. The coil 130 extending along the longitudinal direction may be on the outer surface of the accommodation space 120. The coil 130 may extend in the longitudinal direction to a length corresponding to a length of the susceptor 110 and may be at a position corresponding to a position of the susceptor 110.

FIG. 7 is a block diagram illustrating a hardware configuration of an aerosol generating device.

Referring to FIG. 7, an aerosol generating device 100 may include a battery 140, a controller 150, an alternating current detector 160, a heater HA, and a memory 170.

The battery 140 is a DC power source and may supply a DC voltage to the controller 150 for operation of the aerosol generating device 100. In one embodiment, a regulator (not illustrated) that maintains a voltage of the battery 140 constant may be between the battery 140 and the controller 150.

The controller 150 may include a microcontroller unit (MCU) 151, a pulse width modulation processor 152, an amplifier 153, and an impedance matching unit 154.

The MCU 151 may receive a DC voltage from the battery 140, generate a control signal, and transmit the generated control signal to another component of the aerosol generating device 100. The MCU 151 may control all of the battery 140, the controller 150, the alternating current detector 160, the heater HA, and the memory 170 by using a control signal.

The pulse width modulation processor 152 may receive a DC voltage from the battery 140 and generate a pulse width modulation (PWM) signal under control by the MCU 151. The pulse width modulation processor 152 may change a frequency of the PWM signal within a preset range and transmit the PWM signal to the amplifier 153. According to an embodiment, the pulse width modulation processor 152 may be implemented to be included in the MCU 151, and a PWM signal output from the pulse width modulation processor 152 may be a digital pulse width modulation signal (digital PWM signal). Also, the PWM control signal transmitted from the pulse width modulation processor 152 may also be amplified by the amplifier 153 according to a preset amplification rate.

The amplifier 153 may convert the PWM signal of the DC voltage received from the pulse width modulation processor 152 into an AC voltage. The amplifier 153 may include an array of multiple logic gates.

According to one embodiment, the amplifier 153 may receive two PWM signals having the same waveform from the pulse width modulation processor 152 and perform arithmetic and amplification to convert the two PWM signals into an AC voltage. The amplifier 153 may perform arithmetic and amplification of PWM signals and transmit the PWM signals to a field effect transistor (not illustrated). The arithmetic and amplification of the PWM signals performed by the amplifier 153 may allow the PWM signals to be converted into AC voltages by the field effect transistor. The field effect transistor may be turned on or off according to a PWM signal or may be turned on or off periodically by a built-in timer. According to an embodiment, the field effect transistor may also be replaced with a switch. The amplifier 153 may apply an AC voltage to the coil 130.

The impedance matching unit 154 may be arranged between the amplifier 153 and the heater HA (or the alternating current detector 160), and match the output impedance of the amplifier 153 to the load of the heater HA, and accordingly, an AC voltage may be supplied most.

When an AC voltage is applied to the coil 130 from the amplifier 153 (or the controller 150), a magnetic field is generated by the coil 130. The frequency of an AC voltage transmitted from the amplifier 153 to the coil 130 may be determined according to the frequency of a PWM signal transmitted from the pulse width modulation processor 152 to the amplifier 153. That is, as the frequency of the PWM signal generated by the pulse width modulation processor 152 changes, the frequency of the AC voltage applied to the coil 130 may also change.

The coil 130 may receive an AC voltage from the controller 150. When an AC voltage is applied to the coil 130 from the controller 150, the coil 130 may generate a magnetic field. The intensity of a magnetic field generated by the coil 130 may change depending on the resistance or so on of the coil 130.

The susceptor 110 may be inside the coil 130. The susceptor 110 may heat the cigarette 200 (see FIG. 3) (or an aerosol generating article) by generating heat within a magnetic field generated by the coil 130. The heat generated by the susceptor 110 may change depending on the intensity of the magnetic field generated by the coil 130.

The alternating current detector 160 may detect AC power caused by an inductive coupling phenomenon between the coil 130 and the susceptor 110, and transmit the AC power to the MCU 151.

The alternating current detector 160 according to one embodiment may be a magnetic sensor that detects an alternating current corresponding to the intensity of a magnetic field generated by an inductive coupling phenomenon between the coil 130 and the susceptor 110 and transmits the alternating current to the MCU 151. For example, the magnetic sensor may include at least one of a hall effect sensor, a rotating coil, a giant magnetoresistance device, and a superconducting quantum interference device (SQUID).

The memory 170 may be hardware that stores various data processed by the aerosol generating device 100 and store data processed by the controller 150 and data to be processed thereby. The memory 170 may be implemented in various types of memory, for example, random access memory (RAM), such as dynamic random access memory (DRAM) or static random access memory (SRAM), read-only memory (ROM), and electrically erasable programmable read-only memory (EEPROM).

The memory 170 may store operating time of the aerosol generating device 100, at least one temperature profile, at least one power profile, data on a user's smoking pattern, and so on. In this case, the temperature profile may refer to a temperature change of the susceptor 110 over time, and provide the best smoking experience to a user when the susceptor 110 is heated according to a target temperature profile.

Also, the memory 170 stores AC power generated in the heater HA by an inductive coupling phenomenon and matching data of temperatures of the susceptor 110 in the form of a look-up table, and the control unit 150 may calculate the temperature of the susceptor 110 based on AC power detected by the alternating current detector 160 and the look-up table stored in the memory 170.

According to one embodiment, the look-up table may be prepared in advance during a process of manufacturing the aerosol generating device 100. For example, a plurality of AC voltages may be applied to the heater HA by the controller 150, and the alternating current detector 160 may detect the AC power generated in the heater HA by the plurality of applied AC voltages. In this case, the temperature of the susceptor 110 may be measured by placing a temperature sensor outside and adjacent to the susceptor 110 (or the heater HA), and thereby, matching data of temperatures of the susceptor 110 corresponding to the AC power detected from the heater HA may be obtained.

Accordingly, the aerosol generating device 100 according to an embodiment may monitor the AC power of the heater HA generated by an inductive coupling phenomenon at an input terminal of the heater HA, other than an input terminal of the controller 150, and may accurately calculate the temperature of the susceptor 110 based on the measured AC power and the previously stored look-up table. Thereby, measurement deviation may be reduced compared to the known contact-type temperature sensor, and miniaturization and measurement accuracy may be increased compared to the known noncontact-type temperature sensor.

In addition, when the frequency of an alternating current transmitted from the alternating current detector 160 to the MCU 151 is too high, it is difficult for the MCU 151 having a processing speed (for example, 80 MHZ) generally applied to small devices to follow the frequency, and accordingly, when the frequency of an alternating current is high, an accurate temperature may not be measured. For example, the MCU 151 may perform sampling about 15 times when the frequency of the alternating current is 400 kHz but may perform sampling only once when the frequency of the alternating current is 6 MHZ.

Therefore, as the frequency of the PWM signal generated by the pulse width modulation processor 152 changes, the frequency of an AC voltage applied to the coil 130 may also change, and accordingly, by providing the frequency of the PWM signal at a low frequency, the temperature may be more accurately measured. In order to perform accurate measurement, a frequency range of the PWM signal may be, for example, at least 1 kHz and less than 1 MHZ, and more preferably about 200 kHz to about 500 kHz.

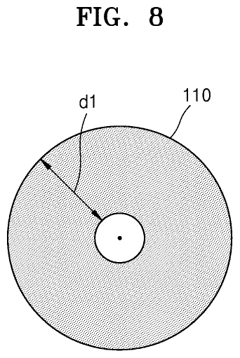

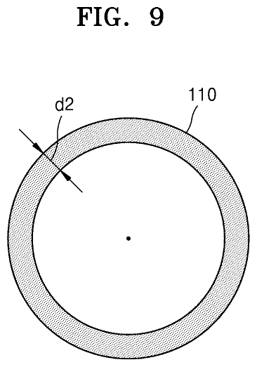

FIGS. 8 and 9 are cross-sectional views of a susceptor to illustrate a skin effect appearing in the susceptor.

Referring to FIGS. 8 and 9, FIG. 8 illustrates the current density when an alternating current having a low frequency is applied to the susceptor 110, and FIG. 9 illustrates the current density when an alternating current having a high frequency is applied to the susceptor 110.

The skin effect refers to a phenomenon in which the more current flows in a surface of a conductor than in the center of the conductor because, when a current flows through a conductor, a magnetic flux generated by the current crosses over the current at the center of the conductor causing the inductance increases. For example, when a direct current flows through a conductor, the current density of the conductor is constant, but when an alternating current flows through the conductor, the current density of a surface of the conductor increases.

In particular, when an alternating current flows through a conductor, the skin effect may appear more as the frequency of the alternating current increases. A penetration depth may be determined by an equation, such as Equation 1 below.

$$d = \frac{1}{\sqrt{π \cdot f \cdot u \cdot σ}} d = \frac{1}{\sqrt{π \cdot f \cdot u \cdot σ}} \qquad Equation 1$$

In this case, d is a penetration depth, f is a frequency of an alternating current, u is permeability of a susceptor, and σ is conductivity of the susceptor.

According to Equation 1, a first penetration depth d1 when an alternating current having a low frequency illustrated in FIG. 8 is applied may be greater than a second penetration depth d2 when an alternating current having a high frequency illustrated in FIG. 9 is applied. That is, because an effective cross-sectional area of the susceptor 110 illustrated in FIG. 8 is greater than an effective cross-sectional area of the susceptor 110 illustrated in FIG. 9, a resistance value of the susceptor 110 in FIG. 8 may be less than a resistance value of the susceptor 110 in FIG. 9. Accordingly, the power transmission capacity is increased more when an alternating current having a low frequency is applied to the susceptor 110 as illustrated in FIG. 8, than when an alternating current having a high frequency is applied to the susceptor 110 as illustrated in FIG. 9, and thus, the cigarette 200 (see FIG. 3) may be efficiently heated.

In other words, as the frequency of a PWM signal generated by the pulse width modulation processor 152 (see FIG. 7) changes, the frequency of an AC voltage applied to the heater HA (see FIG. 7) may also change, and accordingly, when the PWM signal having a low frequency is provided, a skin effect according to the frequency of the PWM signal may be reduced. Also, in order to reduce the skin effect according to the frequency of the PWM signal, the susceptor 110 may have a needle-shaped structure (see FIG. 1) or a rod-shaped structure (see FIG. 4).

Hereinafter, other embodiments are described. In the following embodiments, descriptions of the configurations that are same as in the embodiments described above are omitted or simplified, and differences therebetween are mainly described.

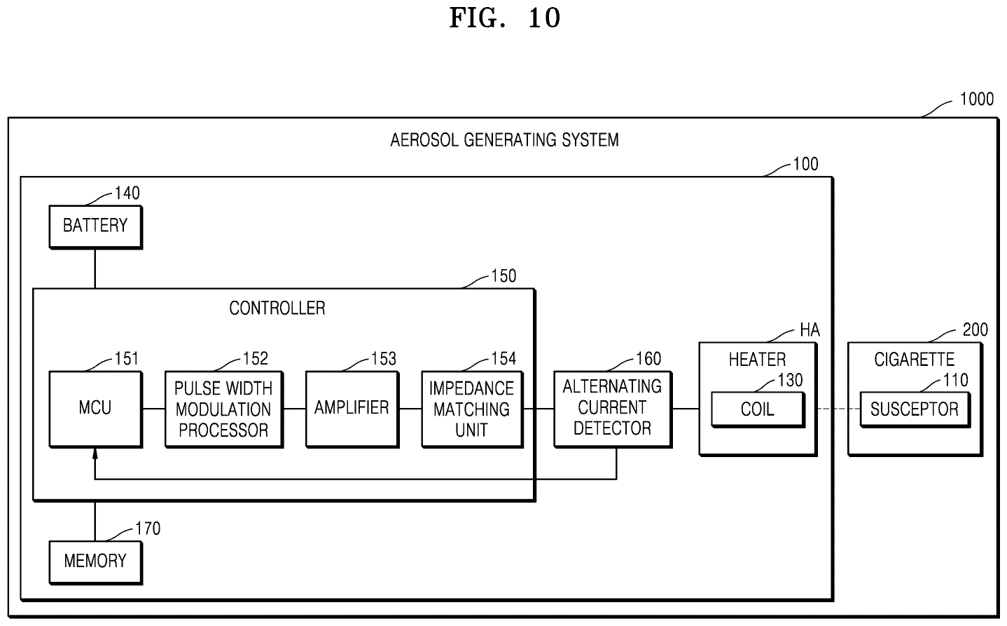

FIG. 10 is a block diagram illustrating a hardware configuration of an aerosol generation system.

An aerosol generating device 100 of an aerosol generating system 1000 illustrated in FIG. 10 is different from the aerosol generating device 100, which is illustrated in FIG. 7, including the susceptor 110 in the heater HA in that a heater HA does not include a susceptor and a cigarette 200 includes a susceptor 110, and the other configurations are substantially the same.

Referring to FIG. 10, the aerosol generating system 1000 may include the aerosol generating device 100 and the cigarette 200.

The cigarette 200 may further include the susceptor 110. In this case, the susceptor 110 may be within the tobacco rod 210 (see FIG. 4) of the cigarette 200. A shape of the susceptor 110 may have a rod shape extending from an end of the tobacco rod 210 in a direction of the filter rod 220 (see FIG. 4).

The aerosol generating device 100 may include a battery 140, a controller 150, an alternating current detector 160, the heater HA, and a memory 170.

The battery 140 is a DC power supply and may supply a DC voltage to the controller 150 to operate the aerosol generating device 100. In one embodiment, a regulator (not illustrated) for maintaining a voltage of the battery 140 constant may be included between the battery 140 and the controller 150.

The controller 150 may include an MCU 151, a pulse width modulation processor 152, an amplifier 153, and an impedance matching unit 154.

The MCU 151 may receive a DC voltage from the battery 140, generate a control signal, and transmit the generated control signal to another component of the aerosol generating device 100. The MCU 151 may control all of the battery 140, the controller 150, the alternating current detector 160, the heater HA, and the memory 170 by using control signals.

When an AC voltage is applied to the coil 130 from the amplifier 153 (or the controller 150), a magnetic field is generated in the coil 130. The frequency of the AC voltage transmitted from the amplifier 153 to the coil 130 may be determined according to the frequency of a PWM signal transmitted from the pulse width modulation processor 152 to the amplifier 153. That is, as the frequency of the PWM signal generated by the pulse width modulation processor 152 changes, the frequency of the AC voltage applied to the coil 130 may also change.

The susceptor 110 may be within the tobacco rod 210 (see FIG. 4) of the cigarette 200. The susceptor 110 may heat the cigarette 200 (see FIG. 4) (or an aerosol generating article) by generating heat within a magnetic field generated by the coil 130. The heat generated by the susceptor 110 may change depending on the intensity of the magnetic field generated by the coil 130.

The alternating current detector 160 may detect AC power caused by an inductive coupling phenomenon between the coil 130 and the susceptor 110, and transmit the AC power to the MCU 151.

The alternating current detector 160 according to one embodiment may be a magnetic sensor that detects an alternating current corresponding to the intensity of a magnetic field generated by an inductive coupling phenomenon between the coil 130 and the susceptor 110 and transmits the alternating current to the MCU 151. For example, the magnetic sensor may include at least one of a hall effect sensor, a rotating coil, a giant magnetoresistance device, and a superconducting quantum interference device (SQUID).

When the frequency of the alternating current transmitted from the alternating current detector 160 to the MCU 151 is too high, it is difficult for the MCU 151, which has a processing speed (for example, 80 MHZ) generally applied to small devices, to follow the alternating current, and accordingly, when the frequency of an alternating current is high, a temperature may not be measured accurately.

Therefore, as the frequency of the PWM signal generated by the pulse width modulation processor 152 changes, the frequency of an AC voltage applied to the coil 130 may also change, and accordingly, by providing a PWM signal having a low frequency, a temperature may be measured more accurately. In order to perform accurate measurement, a frequency range of the PWM signal may be, for example, at least 1 kHz and less than 1 MHZ, and more preferably about 200 kHz to about 500 KHz.

The memory 170 stores the AC power generated in the heater HA by an inductive coupling phenomenon and matching data of temperatures of the susceptor 110 in the form of a look-up table, and the control unit 150 may calculate the temperature of the susceptor 110 based on the AC power detected by the alternating current detector 160 and the look-up table stored in the memory 170.

According to one embodiment, the look-up table may be prepared in advance during a process of manufacturing the aerosol generating device 100. For example, a plurality of AC voltages are applied to the heater HA by the controller 150, and the alternating current detector 160 may detect the AC power generated in the heater HA by the plurality of applied AC voltages. In this case, the temperature of the susceptor 110 may be measured by placing a temperature sensor outside and adjacent to the susceptor 110 (or the heater HA), and thereby, matching data of temperatures of the susceptor 110 corresponding to the AC power detected from the heater HA may be obtained.

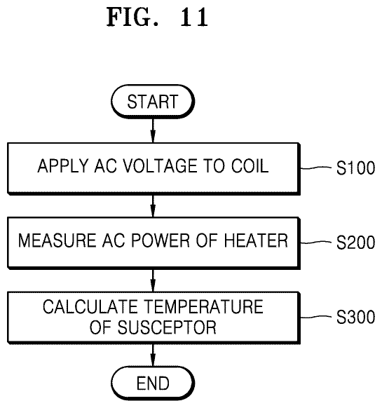

FIG. 11 is a flowchart illustrating an operating method of an aerosol generating device, according to an embodiment.

Referring to FIGS. 1 to 11, an operating method of an aerosol generating device may include operation S100 of applying an AC voltage to the coil 130, operation S200 of measuring the AC power of the heater HA, and operation S300 of calculating the temperature of the susceptor 110.

Specifically, in operation S100 of applying an AC voltage to the coil 130, the aerosol generating device 100 may receive a DC voltage from the battery 140 and generate a PWM signal by using the pulse width modulation processor 152. The amplifier 153 may convert the PWM signal of the DC voltage received from the pulse width modulation processor 152 into an AC voltage.

The frequency of the AC voltage transmitted from the amplifier 153 to the coil 130 may be determined according to the frequency of the PWM signal transmitted from the pulse width modulation processor 152 to the amplifier 153. That is, as the frequency of the PWM signal generated by the pulse width modulation processor 152 changes, the frequency of the AC voltage applied to the coil 130 may also change.

The coil 130 may receive an AC voltage from the controller 150. When an AC voltage is applied to the coil 130 from the controller 150, the coil 130 may generate a magnetic field. The susceptor 110 may heat the cigarette 200 (see FIG. 3 or FIG. 4) by generating heat within a magnetic field generated by the coil 130.

Next, in operation S200 of measuring the AC power of the heater HA, the alternating current detector 160 may detect the AC power caused by an inductive coupling phenomenon between the coil 130 and the susceptor 110, and transmit the AC power to the MCU 151.

The alternating current detector 160 according to one embodiment may be a magnetic sensor that detects an alternating current corresponding to the intensity of a magnetic field generated by an inductive coupling phenomenon between the coil 130 and the susceptor 110 and transmits the alternating current to the MCU 151. For example, the magnetic sensor may include at least one of a hall effect sensor, a rotating coil, a giant magnetoresistance device, and a superconducting quantum interference device (SQUID).

Next, in operation S300 of calculating the temperature of the susceptor 110, the controller 150 may calculate the temperature of the susceptor 150 based on the AC power detected by the alternating current detector 160 and a look-up table stored in the memory 170.

The memory 170 may store, in the form of a look-up table, the AC power generated in the heater HA by an inductive coupling phenomenon and matching data of temperatures of the susceptor 110.

According to one embodiment, the look-up table may be generated in advance during a process of manufacturing the aerosol generating device 100. For example, a plurality of AC voltages may be applied to the heater HA by the controller 150, and the alternating current detector 160 may detect the AC power generated in the heater HA by the plurality of applied AC voltages. In this case, the temperature of the susceptor 110 may be measured by placing a temperature sensor outside and adjacent to the susceptor 110 (or the heater HA), and thereby, matching data of temperatures of the susceptor 110 corresponding to the AC power detected from the heater HA may be obtained.

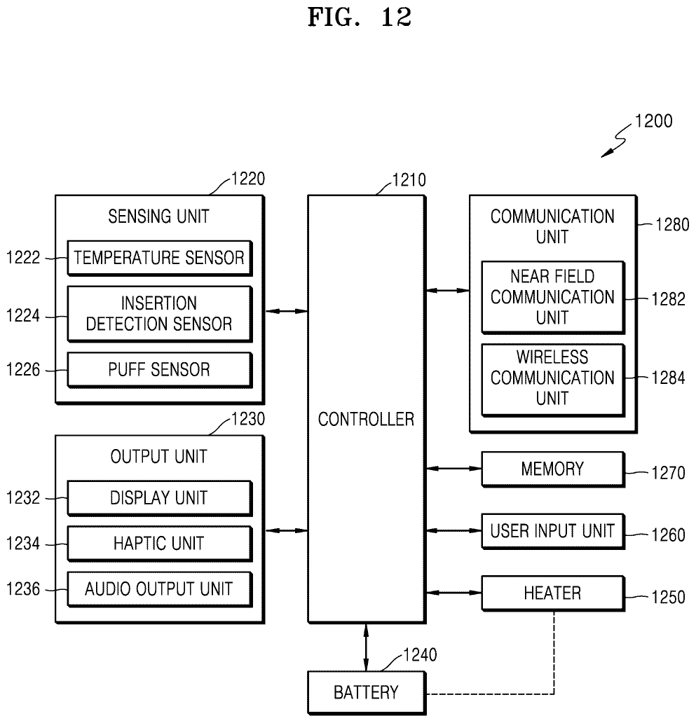

FIG. 12 is a block diagram of an aerosol generating device 1200 according to another embodiment.

The aerosol generating device 1200 may include a controller 1210, a sensing unit 1220, an output unit 1230, a battery 1240, a heater 1250, a user input unit 1260, a memory 1270, and a communication unit 1280. However, the internal structure of the aerosol generating device 1200 is not limited to those illustrated in FIG. 12. That is, according to the design of the aerosol generating device 1200, it will be understood by one of ordinary skill in the art that some of the components shown in FIG. 12 may be omitted or new components may be added.

The sensing unit 1220 may sense a state of the aerosol generating device 1200 and a state around the aerosol generating device 1200, and transmit sensed information to the controller 1210. Based on the sensed information, the controller 1210 may control the aerosol generating device 1200 to perform various functions, such as controlling an operation of the heater 1250, limiting smoking, determining whether an aerosol generating article (e.g., a cigarette, a cartridge, or the like) is inserted, displaying a notification, or the like.

The sensing unit 1220 may include at least one of a temperature sensor 1222, an insertion detection sensor, and a puff sensor 1226, but is not limited thereto.

The temperature sensor 1222 may sense a temperature at which the heater 1250 (or an aerosol generating material) is heated. The aerosol generating device 1200 may include a separate temperature sensor for sensing the temperature of the heater 1250, or the heater 1250 may serve as a temperature sensor. Alternatively, the temperature sensor 1222 may also be arranged around the battery 1240 to monitor the temperature of the battery 1240. In an embodiment, the temperature sensor 1222 may measure the temperature of the heater 1250 before it is heated.

The insertion detection sensor 1224 may sense insertion and/or removal of an aerosol generating article. For example, the insertion detection sensor 1224 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article. If the insertion detection sensor 1224 detects insertion of the aerosol-generating article and then detects insertion of the aerosol-generating article again within a predetermined time after the one-time smoking series ends, it may be determined to be continuous use.

The puff sensor 1226 may sense a user's puff on the basis of various physical changes in an airflow passage or an airflow channel. For example, the puff sensor 1226 may sense a user's puff on the basis of any one of a temperature change, a flow change, a voltage change, and a pressure change.

The sensing unit 1220 may include, in addition to the temperature sensor 1222, the insertion detection sensor 1224, and the puff sensor 1226 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1230 may output information on a state of the aerosol generating device 1200 and provide the information to a user. The output unit 1230 may include at least one of a display unit 1232, a haptic unit 1234, and a sound output unit 1236, but is not limited thereto. When the display unit 1232 and a touch pad form a layered structure to form a touch screen, the display unit 1232 may also be used as an input device in addition to an output device.

The display unit 1232 may visually provide information about the aerosol generating device 1200 to the user. For example, information about the aerosol generating device 1200 may mean various pieces of information, such as a charging/discharging state of the battery 1240 of the aerosol generating device 1200, a preheating state of the heater 1250, an insertion/removal state of an aerosol generating article, or a state in which the use of the aerosol generating device 1200 is restricted (e.g., sensing of an abnormal object), or the like, and the display unit 1232 may output the information to the outside. The display unit 1232 may be, for example, a liquid crystal display panel (LCD), an organic light-emitting diode (OLED) display panel, or the like. In addition, the display unit 1232 may be in the form of a light-emitting diode (LED) light-emitting device.

The haptic unit 1234 may tactilely provide information about the aerosol generating device 1200 to the user by converting an electrical signal into a mechanical stimulus or an electrical stimulus. For example, the haptic unit 1234 may include a motor, a piezoelectric element, or an electrical stimulation device.

The sound output unit 1236 may audibly provide information about the aerosol generating device 1200 to the user. For example, the sound output unit 1236 may convert an electrical signal into a sound signal and output the same to the outside.

The battery 1240 may supply power used to operate the aerosol generating device 1200. The battery 1240 may supply power such that the heater 1250 may be heated. In addition, the battery 1240 may supply power required for operations of other components (e.g., the sensing unit 1220, the output unit 1230, the user input unit 1260, the memory 1270, and the communication unit 1280) in the aerosol generating device 1200. The battery 1240 may be a rechargeable battery or a disposable battery. For example, the battery 1240 may be a lithium polymer (LiPoly) battery, but is not limited thereto.

The heater 1250 may receive power from the battery 1240 to heat an aerosol generating material. Although not illustrated in FIG. 12, the aerosol generating device 1200 may further include a power conversion circuit (e.g., a direct current (DC)/DC converter) that converts power of the battery 1240 and supplies the same to the heater 1250. In addition, when the aerosol generating device 1200 generates aerosols in an induction heating method, the aerosol generating device 1200 may further include a DC/alternating current (AC) that converts DC power of the battery 1240 into AC power.

The controller 1210, the sensing unit 1220, the output unit 1230, the user input unit 1260, the memory 1270, and the communication unit 1280 may each receive power from the battery 1240 to perform a function. Although not illustrated in FIG. 12, the aerosol generating device 1200 may further include a power conversion circuit that converts power of the battery 1240 to supply the power to respective components, for example, a low dropout (LDO) circuit, or a voltage regulator circuit.

In an embodiment, the heater 1250 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1250 may be implemented by a metal wire, a metal plate on which an electrically conductive track is arranged, a ceramic heating element, or the like, but is not limited thereto.

In another embodiment, the heater 1250 may be a heater of an induction heating type. For example, the heater 1250 may include a suspector that heats an aerosol generating material by generating heat through a magnetic field applied by a coil.

In one embodiment, the heater 1250 may include a plurality of heaters. For example, the heater 1250 may include a first heater for heating a cigarette and a second heater for heating a liquid.

The user input unit 1260 may receive information input from the user or may output information to the user. For example, the user input unit 1260 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 12, the aerosol generating device 1200 may further include a connection interface, such as a universal serial bus (USB) interface, and may connect to other external devices through the connection interface, such as the USB interface, to transmit and receive information, or to charge the battery 1240.

The memory 1270 is a hardware component that stores various types of data processed in the aerosol generating device 1200, and may store data processed and data to be processed by the controller 1210. The memory 1270 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1270 may store an operation time of the aerosol generating device 1200, the maximum number of puffs, the current number of puffs, at least one temperature profile, data on a user's smoking pattern, etc. In embodiments, the memory 1270 may store multiple temperature profiles. Additionally, the memory 1270 may store a plurality of preheating profiles that define preheating sections among the temperature profiles.

The communication unit 1280 may include at least one component for communication with another electronic device. For example, the communication unit 1280 may include a short-range wireless communication unit 1282 and a wireless communication unit 1284.

The short-range wireless communication unit 1282 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1284 may include a cellular network communication unit, an Internet communication unit, a computer network (e.g., local area network (LAN) or wide area network (WAN)) communication unit, or the like, but is not limited thereto. The wireless communication unit 1284 may also identify and authenticate the aerosol generating device 1200 within a communication network by using subscriber information (e.g., International Mobile Subscriber Identifier (IMSI)).

The controller 1210 may control general operations of the aerosol generating device 1200. In an embodiment, the controller 1210 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

Those of ordinary skill in the art related to the present embodiments may understand that various changes in form and details can be made therein without departing from the scope of the characteristics described above. Therefore, the disclosed methods should be considered in a descriptive point of view, not a restrictive point of view. The scope of the present disclosure is defined by the appended claims rather than by the foregoing description, and all differences within the scope of equivalents thereof should be construed as being included in the present disclosure.

1. An aerosol generating device comprising:
a heater including a coil and a susceptor;
an alternating current detector configured to detect alternating current power caused by an inductive coupling phenomenon between the coil and the susceptor;
a memory storing a look-up table including temperature matching data about the susceptor, the temperature matching data corresponding to the alternating current power; and
a controller configured to calculate a temperature of the susceptor based on the alternating current power received from the alternating current detector based on the look-up table.

2. The aerosol generating device of claim 1, wherein the alternating current detector includes a magnetic sensor configured to detect an alternating current corresponding to an intensity of a magnetic field generated between the coil and the susceptor and provide the alternating current to the controller.

3. The aerosol generating device of claim 2, wherein the magnetic sensor includes one of a hall effect sensor and a giant magnetoresistance device.

4. The aerosol generating device of claim 1, further comprising a battery configured to supply a DC voltage to the controller.

5. The aerosol generating device of claim 4, wherein the controller includes:
a pulse width modulation processor configured to receive the DC voltage from the battery and generate a pulse width modulation (PWM) signal; and
an amplifier configured to generate an alternating current voltage by amplifying the PWM signal according to a preset amplification rate and provide the alternating current voltage to the coil.

6. The aerosol generating device of claim 5, wherein the controller further includes an impedance matching unit arranged between the amplifier and the alternating current detector and configured to perform impedance matching to increase supply of the alternating current voltage.

7. The aerosol generating device of claim 5, wherein a frequency of the alternating current voltage is changed to correspond to a change in a frequency of the PWM signal.

8. The aerosol generating device of claim 7, wherein the controller is further configured to control the frequency of the PWM signal to be in a low frequency range between about 200 kHz to about 500 KHz.

9. The aerosol generating device of claim 7, wherein the susceptor has a needle-shaped structure to reduce a skin effect according to the frequency of the PWM signal.

10. An aerosol generation system comprising:
a cigarette including a susceptor; and
an aerosol generating device,
wherein the aerosol generating device comprises:
a heater including a coil for inductively heating the susceptor;
an alternating current detector configured to detect alternating current power generated by an inductive coupling phenomenon between the coil and the susceptor;
a memory storing a look-up table including temperature matching data about the susceptor, the temperature matching data corresponding to the alternating current power; and
a controller configured to calculate a temperature of the susceptor based on the detected alternating current power and the look-up table.

11. The aerosol generating system of claim 10, wherein the alternating current detector includes a magnetic sensor configured to detect an alternating current corresponding to an intensity of a magnetic field generated between the coil and the susceptor and provide the alternating current to the controller.

12. The aerosol generating system of claim 10, further comprising a battery configured to supply a DC voltage to the controller.

13. The aerosol generating system of claim 12, wherein the controller includes:
a pulse width modulation processor configured to receive the DC voltage from the battery and generate a pulse width modulation (PWM) signal; and
an amplifier configured to generate an alternating current voltage by amplifying the PWM signal according to a preset amplification rate and provide the alternating current voltage to the coil.

14. The aerosol generating system of claim 13, wherein the controller is further configured to control the frequency of the PWM signal to be in a low frequency range between about 200 kHz to about 500 KHz.

15. The aerosol generating system of claim 13, wherein the susceptor has a needle-shaped structure to reduce a skin effect according to the frequency of the PWM signal.
